(19) United States
(12) Patent Application Publication
(10) Pub. No.: US 2006/0069676 A1
(43) Pub. Date: Mar. 30, 2006

(54) Folder generating system, method of generating folder, program for generating folder

(76) Inventors: Kazunori Takatsu, Kanagawa (JP); Yukiko Sahashi, Kanagawa (JP)

Correspondence Address: DICKSTEIN SHAPIRO MORIN & OSHINSKY LLP, 2101 L Street, NW, Washington, DC, 20037, US

(21) Appl. No.: 11/239,352

(22) Filed: Sep. 30, 2005

(30) Foreign Application Priority Data
Sep. 30, 2004 (JP) 2004-287097

(51) Int. Cl. G06F 17/30

(52) U.S. Cl. 707/3

(57) ABSTRACT

A folder generating system includes a location managing unit, an identification information controlling unit, an extracting unit, and a folder generating unit. The location managing unit stores information of personnel, including a first member having a first identification, with respective identifications, detection locations and detection time. The identification information controlling unit receives the first identification from the first member when the first member requests a folder generation at a reference time. The extracting unit searches the location managing unit for a latest location of the first member using the first identification, and extracts identifications of other members, being presented with the first member at a substantially same time, by searching the location managing unit using the latest location of the first member. The folder generating unit generates a folder accessible by the first member and other members having the identifications extracted by the extracting unit.

### TECHNICAL FIELD

The present discloser generally relates to a folder generating system, method of generating folder, and a program for generating folder.

### BACKGROUND

With an widespread popularity of compact personal computers (PCs) such as notebook PC, meeting participants can bring their own personal mobile computers when they attend meetings held in companies or the like, and they use the personal mobile computers to store a variety of information such as personal notes, minutes of meeting, reference documents or the like. After the meeting they use such information, as required.

However, meeting participants who have no own personal mobile computers may not store such information, thereby they may not directly access to such information.

Therefore, when the meeting participants want to further discuss on the issues raised in the meeting, they may feel some oddness for such discussion because some person can refer to the above-mentioned information through his or her computers but some person cannot refer to the above-mentioned information through his or her computers.

Under such environment, the meeting participants may need a relatively longer time just for understanding or reminding information for the issue.

Because of such inconveniences, it has been hoped to establish a computer network environment, which can share information by a plurality of persons by generating shared folders.

A background art can automatically generate a shared folder for each meeting, in which a link can be automatically generated to such shared folder to facilitate efficient communication among meeting participants.

In the above-mentioned art, an access right is assigned to each participant so that shared folders can be used by the meeting participants. Because participants are different for each meeting, it is hard to identify participants for each meeting, thereby a system administrator should conduct access control settings to the shared folder, which leads to a heavy working load to the system administrator.

In another background art, access-right control for shared folder is not conducted by a system administrator, but a person who transmits information at first can conduct access-right control to lessen a working load of the system administrator, and to facilitate participants to take an active role (e.g., ad hoc system administrator) for establishing information sharing group.

In the above-mentioned art, a working load of the system administrator may be reduced, but a person who transmits information to the shared folder at first needs to set access-right control, thereby working load may not reduced after all.

Furthermore, any person who transmits information to the shared folder at first can freely set access-right control to the shared folders in a same level of the system administrator, thereby any person may discretionally set an unauthorized access right for any persons, which may lead to an deterioration of information security of shared folders.

### SUMMARY

The present disclosure relates to a folder generating system coupled to a plurality of terminals via a network. The folder generating system includes a location managing unit, an identification information controlling unit, an extracting unit, and a folder generating unit. The location managing unit stores information of personnel, including a first member having a first identification, with respective identifications, detection locations and detection time. The identification information controlling unit receives the first identification from the first member when the first member requests a folder generation through one of the plurality of terminals via the network at a reference time. The extracting unit searches the location managing unit for a latest location of the first member using the first identification received by the identification information controlling unit, and extracts identifications of other members, being presented with the first member at a substantially same time, by searching the location managing unit using the latest location of the first member. The folder generating unit generates a folder accessible by the first member and other members having the identifications extracted by the extracting unit.

### BRIEF DESCRIPTION OF THE DRAWINGS

A more complete appreciation of the disclosure and many of the attendant advantages and features thereof can readily be obtained and understood from the following detailed description with reference to the accompanying drawings, wherein:

FIG. 1 is a schematic diagram of a folder generating system according to one example embodiment;

FIG. 2 is a location management table for a folder generating system according to one example embodiment;

FIG. 3 is a flow chart explaining a method of generating a folder with a folder generating system according to one example embodiment;

FIG. 4 is a schematic display view for an inquiry screen used in a folder generating system according to one example embodiment; and

FIG. 5 is a schematic display view for a user selecting and adding screen used in a folder generating system according to one example embodiment.

### DETAILED DESCRIPTION OF EXAMPLE EMBODIMENTS

In describing example embodiments shown in the drawings, specific terminology is employed for the sake of clarity. However, the disclosure of this present invention is not intended to be limited to the specific terminology so selected and it is to be understood that each specific element includes all technical equivalents that operate in a similar manner.

Referring now to the drawings, wherein like reference numerals designate identical or corresponding parts throughout the several views, a folder generating system, a method of generating folder, and a program for generating a folder are described.

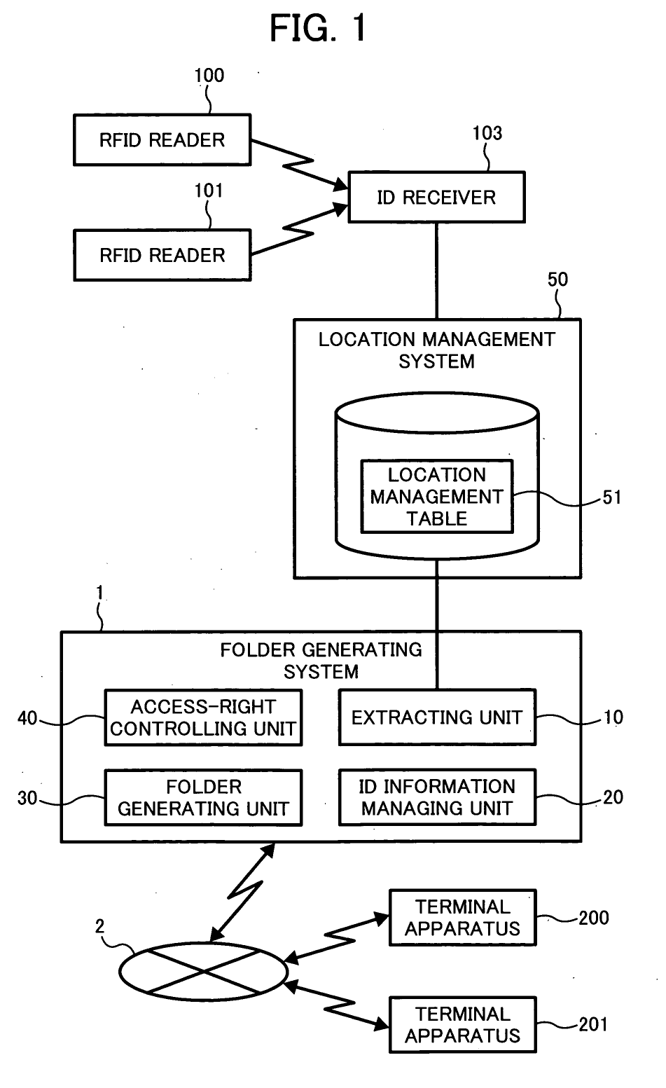

FIG. 1 is a schematic diagram of a folder generating system according to one example embodiment.

The folder generating system is used to generate a folder (i.e., shared folder) to be shared by a plurality of members assigned with access right to the folder.

As shown in FIG. 1, the folder generating system includes a folder generating unit 1, RFID (radio frequency identification) readers 100 and 101, an ID (identification) receiver 103, a location management system 50, terminal apparatuses 200 and 201, and a network 2.

As shown in FIG. 1, the folder generating unit 1 communicates information with the terminal apparatuses 200 and 201 through the network 2.

As shown in FIG. 1, the folder generating unit 1 includes an extracting unit 10, an ID information managing unit 20, a folder generating unit 30, and access-right controlling unit 40.

The ID receiver 103 can receive location information of members from the RFID readers 100 and 101.

For example, although not shown in FIG. 1, each member has a RFID tag which transmits user ID, unique to each member.

Thereby, the ID receiver 103 receives respective user IDs when a member in a certain distance from the ID receiver 103. Accordingly, the location information of each member can be determined.

Although the RFID tag and the ID receiver using radio frequency are used in this one example embodiment, any types of tags such as IR (infra-red) tag and ultrasonic tag can be used, as required.

Then, the location management system 50 receives the location information from the ID receiver 103, and stores the location information in the location management table 51.

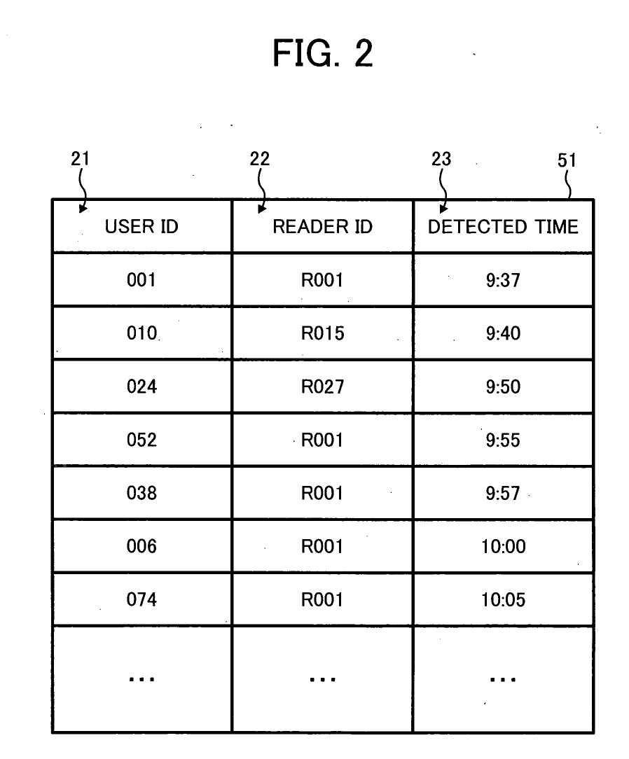

As shown in FIG. 2, the location management table 51 stores and manages user IDs, reader IDs, and detected time by matching the user ID, reader ID, and detected time. Therefore, the location management table 51 stores information that can indicate what member presents at what location at what time.

Although two RFID readers are used in FIG. 1, any number of RFID readers can be used.

The extracting unit 10 obtains location information of members from the location management system 50, and extracts members to be assigned with access right for a folder.

The ID information managing unit 20 receives a first user ID of a first member from the terminal apparatus 200 or 201 when the first member have requested a folder generation. The first user ID of the first member is used identify a present location of the first member who has requested a generation of the folder.

Furthermore, after the folder is generated, link information for the folder can be transmitted to members, who are assigned with access right, by electronic transmission such as e-mail.

Although two terminal apparatuses are used in FIG. 1, any number of terminal apparatuses can be used.

The folder generating unit 30 generates a folder, and sets access right for the folder to members extracted by the extracting unit 10.

The access-right controlling unit 40 inquires the first member whether other members, to be assigned with access right as a result of an operation of the folder generating unit 30, are eligible to have an access right.

In the above-mentioned one example embodiment, a process for obtaining location information by using RFID method can be conducted with publicly-known methods.

Hereinafter, a process of generating a folder with the folder generating system is explained.

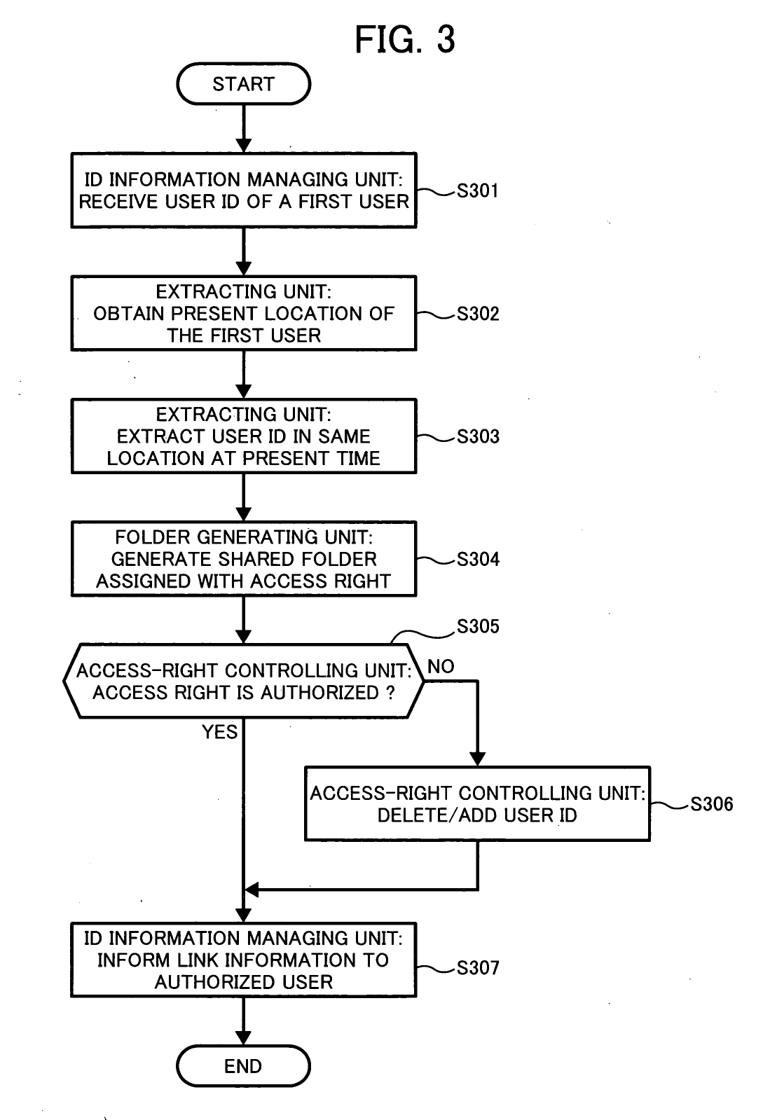

FIG. 3 is a flow chart explaining a process of generating a folder with the folder generating system.

In Step S301, the ID information managing unit 20 receives an user ID of a first member, wherein the first member requests a folder generation to the folder generating unit 1 at a reference time.

The reference time becomes a baseline time to determine a time period to be used for determining whether each member presents with the first member at a substantially same time.

The ID information managing unit 20 transmits the user ID information of the first member to the extracting unit 10.

In Step 302, the extracting unit 10 obtains a present (or latest) location of the first member by referring to the location management table 51 in the location management system 50 with the first user ID.

In Step 303, the extracting unit 10 further refers to the location management table 51, and extracts user IDs of other members (i.e., other than the first member). In this process, the extracting unit 10 extracts user IDs of other members, who presents with the first member at the substantially same time, by using the location management system 50.

The substantially same time is defied as a predetermined time period including the reference time. For example, the predetermined time period is a time period which is plus/minus from the reference time.

If detected time for each of other members is within the above-mentioned predetermined time period, they may be present with the first member.

If detected time for each of other members is not within the above-mentioned predetermined time period, they may not be present with the first member.

Then, the extracting unit 10 transmits the first user ID and other user IDs extracted by the extracting unit 10 to the folder generating unit 30.

In Step 304, the folder generating unit 30 generates a folder, and assigns access right for the folder to the other user IDs extracted by the extracting unit 10.

In Step 305, the access-right controlling unit 40 inquires the first member whether access right of the other members to the folder is eligible or not.

If the CPU determines that the access right of the other members to the folder is eligible, the access-right controlling unit 40 transmits link information for the folder and the user IDs of other members to the ID information managing unit 20, and the process goes to Step 307.

If the CPU determines that the access right of the other members to the folder is not eligible, the process goes to Step 306 to delete such members.

Furthermore, if the first user wants to add another member (i.e., user ID) as a members eligible to have access right, such members can be added in Step 306.

As such, the access-right controlling unit 40 can delete a user ID or add a user ID in Step 306.

In Step 307, the ID information managing unit 20 informs the link information for the folder to the member (i.e., user IDs) having eligible access right, which is received from the access-right controlling unit 40.

Such link information can be communicated to the member by e-mail, but other methods can be used, as required.

Hereinafter, one example applying the folder generating system to a generation of a folder for meeting participants is explained.

In one day, a meeting of four participants is held from 10:00 AM at the first meeting room. The four participants have user IDs of “052”, “038”, “006”, and “074,” for example. The first meeting room is equipped with a RFID reader having a reader ID of “R001.”

At 10:05 AM, all four participants are in the first meeting room.

Then, a first member having user ID “006” requests a folder generation to the folder generating unit 1 from a first terminal apparatus (e.g. PC), which belongs to the first member.

The ID information managing unit 20 receives the user ID “006”, and transmits the user ID “006” to the extracting unit 10. Then the extracting unit 10 refers to the location management table 51 of the location management system 50 to search the user ID “006.”

FIG. 2 shows location information of a plurality of members registered in the location management table 51 when the meeting is held.

The extracting unit 10 searches the user ID column 21 in the location management table 51, and finds the user ID “006.” Then, extracting unit 10 searches the reader ID column 22 to find a reader ID corresponded to the user ID “006,” and the reader ID “R001” is obtained as a search result.

With such process, it is determined that the first member having the user ID “006” is in the first meeting room.

Next, the extracting unit 10 refers to the reader ID column 22 again to search the reader ID “R001”, and extracts user IDs corresponding to the reader ID “R001.” At this time, the extracting unit 10 does not extract the user ID “006.”

Because user IDs “001,” “052,” “038,” and “074” correspond to the reader ID “R001” as shown in FIG. 2, the extracting unit 10 extracts “001,” “052,” “038,” and “074” by such searching.

Therefore, members having a same reader ID of the first member can be extracted.

In other words, the extracting unit 10 extracts members who might be present with the first member in a same location (or place) by such searching.

The extracting unit 10 obtains detected time, corresponding to the extracted four member having user IDs of “001,” “052,” “038,” and “074”, from the detected time column 23.

Detected time means a time when a user ID is received by the RFID reader 100.

Then, the extracting unit 10 extracts user IDs from the four user IDs (“001,” “052,” “038,” and “074”), whose detected time of is within a predetermined time period including reference time.

For example, the predetermined time period can be set to a plus/minus 10-minute from the reference time.

Because the reference time is 10:05 AM in this example, the extracting unit 10 extracts user IDs of “052,” “038,” and “074,” which have the detected time from 9:55 to 10:15 AM.

With such process, members being presented in a same location of the first member at the predetermined time period can be correctly extracted.

Therefore, a person who was in the same location but presented in past (e.g., person not attending the meeting) can be excluded from the extracted result.

The folder generating unit 30 generates a folder which is accessible by the first member and other members whose user IDs are extracted by the extracting unit 10.

Furthermore, the access-right controlling unit 40 inquires the first member whether the persons assigned with access right are eligible or not by using an inquiry screen.

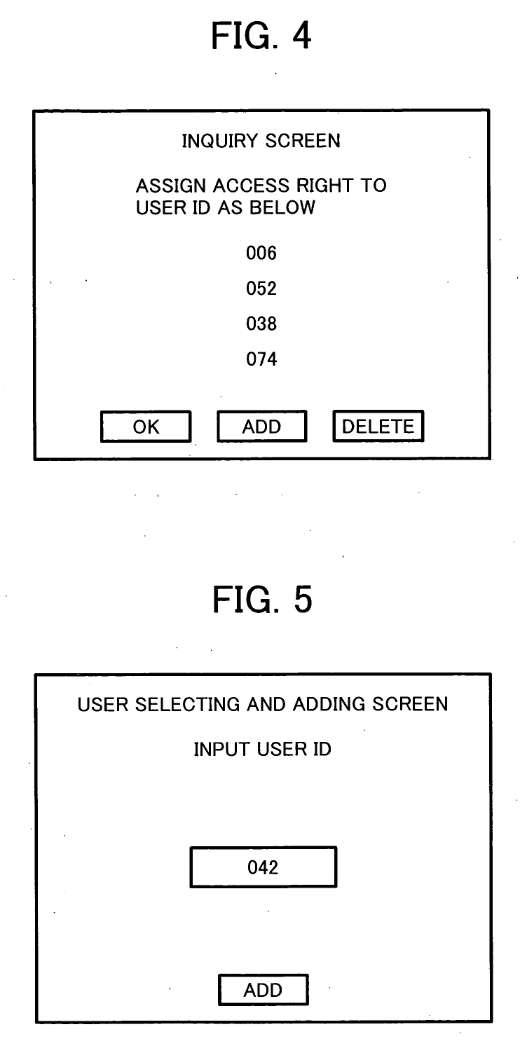

FIG. 4 is one example of an inquiry screen. In FIG. 4, the user IDs of members (i.e., participants) and the user IDs assigned with the access right are correctly corresponded, therefore, the first member presses the “OK” button.

Furthermore, the first membermay want to assign an access right to a supervisor of the first member, having the user ID “042,” but not attending the meeting.

In such a case, on the inquiry screen in FIG. 4, the first member presses the “ADD” button to display a user selecting and adding screen shown in FIG. 5. FIG. 5 is one example of a user selecting and adding screen.

As shown in FIG. 5, the first member inputs “042” in a user ID information field on the user selecting and adding screen, and presses the “ADD” button.

Then, the access-right controlling unit 40 conducts an additional assigning process, which assigns access right to the user ID “042.”

As such, the assigning process for access right is inquired to the first member, who have requested a generation of the folder, so that information security for the folder can be maintained.

The ID information managing unit 20 transmits an e-mail including link information for the folder to the person having the user ID assigned with access right, and the person who received the e-mail can access the folder from the link information.

As such, in the above-described one example embodiment, participants being presented in a meeting room can be extracted by using RFID. And the CPU judges that the participants, being presented in a same meeting room at the same time, attend the same meeting.

Therefore, when generating a folder and assigning access right to the participants attending the same meeting, the CPU can automatically determine members to be assigned with access right, thereby a working load of folder manager (e.g., system administrator) can be reduced.

Furthermore, in the above-described one example embodiment, the access right to the folder can be assigned to authorized members automatically, thereby the access right to the folder may not be assigned to unauthorized members, which results into an improvement of information security of folders.

In the above-described one example embodiment, the folder generating system is used when generating a folder for a meeting participants.

However, the folder generating system can be used for other cases such as using a folder by a plurality of members working in a same area or section, for example.

In the above-described one example embodiment, the folder generating system is used to generate folder and assign access right. Such folder can include any types of reference materials such as written document, word-processed documents, audio and/or visual materials, drawings, and memorandums written on whiteboard, for example.

In the above-described one example embodiment, a member can send his (or her) own user ID, which is used for determining location of other members, to the ID information managing unit 20 by inputting the user ID through terminal apparatus 200 when generating a folder. However, actual user ID has a relatively long random sequence of characters (e.g., numbers and alphabets), thereby memorizing and inputting the user ID itself is a heavy workload for members. In such a case, following configuration can be used to input a user ID.

For example, assume a case that a login account of a member is corresponded to a user ID in advance. In this case, when a member activates (i.e., logs in) the terminal apparatus to request a generation of folder, the member can send his (or her) own user ID to the ID information managing unit 20 by inputting login account (e.g., member name) instead of the user ID. Then, such user ID can be corresponded to the RFID reader ID.

In the above-described one example embodiment, access right is assigned to members (e.g., first member and other members) who present in a substantially same location at a substantially same time.

However, the folder generating system used in the above-described one example embodiment can also be used for assigning the access right to members who does not exist in the same location but attend a same meeting.

Specifically, the folder generating system can be used to assign the access right to members who live in remote area each other and attend a same meeting using a remote communication system such as television or telephone meeting.

When a meeting is held between members living in remote area each other, a generation of folder and access right assigning to members (i.e., meeting participants) can be conducted in a following manner.

In this case, a folder can be generated in similar manner explained in the above-described one example embodiment.

Therefore, a method of assigning access right for the folder to the members living in remote area each other is explained hereinafter.

For simplifying explanation, it is assumed that two groups (e.g., first and second groups), being presented in remote area each other but provided with a network system having the folder generating system described with FIG. 1, hold a remote meeting such as television meeting.

The first group, including a first member and other participants, is in a first area, and the second group, including a second member and other participants, is in a second area which is remote from the first area.

Each of the first and second area is equipped with a first RFID reader and a second RFID reader, respectively.

The first member has a first user ID “X,” and the second member has a second user ID “Y.”

At first, the first member having the user ID “X” requests a generation of a folder when to start the remote meeting, wherein this timing is referred as “reference time,” as required.

In case of the first group, all participants including the first member present in a same are (i.e., the first area), thereby access right can be assigned to all participants of the first group with a method explained in the above-described one example embodiment.

In case of the second group, participants including the second member present in the second area (i.e., not in the first area), thereby a modified step is required to assign access right to participants of the second group.

Specifically, the first member input a name of the second member having the second user ID “Y,” and requests the folder generating system to search the location of the second member using the second user ID “Y.”

Different from the above-described one example embodiment, which can determine location of meeting participants automatically, the first member needs to know name of at least one person (e.g., second member) of the second group to identify a location of the second group automatically.

Once the location of the second member can be identified as below, user IDs of other participants can be identified from the location information of the second member because participants of the second group present with the second member. In other words, the second member (i.e., second user ID) functions as key information to identify location information of the second group, and subsequently to identify user IDs of other participants in the second group.

The second user ID “Y” of the second member is received by the second RFID reader, and then stored in the location management table 51 of the location management system 50 with information of the second RFID reader ID and detected time.

Because the second RFID reader ID is matched to the second area, the location information of the second member can be identified as “second area.”

The extracting unit 10 extracts user IDs corresponding to the second RFID reader ID from the location management table 51, and identify the user IDs (i.e., other participants of the second group) being presented in the second area. In such a way, user IDs of the participants of the second group can be identified.

With such processes, user IDs of all participants of the first and second groups can be identified.

The extracting unit 10 transmits the user IDs of the first and second group to the folder generating unit 30.

The folder generating unit 30 generates a folder with assigning the access right for the folder to the all participants of the first and second group.

In this way, the location of the second group at the time of remote meeting can be determined, and the access right for the folder can be assigned to the second group in addition to the first group.

Furthermore, when a third group including a third member (key information), being presented in another remote area, attends the remote meeting, access right can be also assigned to the third group in a similar manner.

As such, even if a plurality of groups (or members), being presented in remote area with each other, attend a same remote meeting, access right for a folder can be assigned to each group (or member) in a similar manner of the above-described one example embodiment for identifying members (i.e., user IDs) being presented in a substantially same area.

In the above-described example embodiments, the folder generating system includes a control devices such as CPU (central processing unit), graphic board, ROM (read only memory); a main storing device such as main memory, RAM (random access memory); storing medium such as hard disk, CD-ROM, floppy (registered trademark); an external storing device such as drive device controlling read/write to the storing medium; a communication device such as Ethernet (registered trademark) board or modem; an output device such as display and printer; and an input device such as keyboard and mouse, wherein the above-mentioned components may be integrated as a computer such as work station (WS), and personal computer (PC).

The above-described disclosure may be conveniently implemented using a conventional general purpose digital computer programmed according to the teaching of the present specification, as will be apparent to those skilled in art in the computer art. Appropriate software coding can readily be prepared by skilled programmers based on the teaching of the present disclosure, as will be apparent to those skilled in art in the software art. The present invention may also be implemented by the preparation of the application specific integrated circuits or by interconnecting an appropriate network of conventional component circuits, as will be apparent to those skilled in the art.

Numerous additional modifications and variations are possible in light of the above teachings. It is therefore to be understood that within the scope of the appended claims, the disclosure of the present invention may be practiced otherwise than as specifically described herein.

This application claims priority from Japanese patent application No. 2004-287097 filed on Sep. 30, 2004 in the Japan Patent Office, the entire contents of which are hereby incorporated by reference herein.

What is claimed is:

1. A folder generating system coupled to a plurality of terminals via a network, comprising:
a location managing unit configured to store information of personnel, including a first member having a first identification, with respective identifications, detection locations and detection time;
an identification information controlling unit configured to receive the first identification from the first member when the first member requests a folder generation through one of the plurality of terminals via the network at a reference time;
an extracting unit configured to search the location managing unit for a latest location of the first member using the first identification received by the identification information controlling unit, and to extract identifications of other members, being presented with the first member at a substantially same time, by searching the location managing unit using the latest location of the first member; and
a folder generating unit configured to generate a folder accessible by the first member and other members having the identifications extracted by the extracting unit.

2. The folder generating system according to claim 1, wherein each of the personnel has an identification tag, which transmits respective identifications.

3. The folder generating system according to claim 2, wherein the respective identification is read by an identification reader.

4. The folder generating system according to claim 1, further comprising an access-right controlling unit configured to control assignment of access right for the folder by deleting a member not eligible to have access right and adding a member eligible to have access right.

5. The folder generating system according to claim 1, wherein the folder generating unit informs link information of the folder to the first member and other members having the identifications extracted by the extracting unit.

6. The folder generating system according to claim 1, wherein the substantially same time is defined as a predetermined time period including the reference time.

7. A folder generating system coupled to a plurality of terminals via a network, comprising:
means for storing information of personnel, including a first member having a first identification, with respective identifications, detection locations and detection time;
means for receiving the first identification from the first member when the first member requests a folder generation through one of the plurality of terminals via the network at a reference time;
means for searching the means for storing for a latest location of the first member using the first identification received by the means for receiving, and extracting identifications of other members, being presented with the first member at a substantially same time, by searching the means for storing using the latest location of the first member; and
means for generating a folder accessible by the first member and other members having the identifications extracted by the means for searching.

8. A method of generating a folder to be shared by a plurality of members, comprising the steps of:
storing information of personnel, including a first member having a first identification, with respective identifications, detection locations and detection time;
receiving the first identification from the first member when the first member requests a folder generation at a reference time;
detecting a latest location of the first member from the stored information of personnel using the first identification received at the receiving step;
extracting identifications of other members, being presented with the first member at a substantially same time from the stored information of personnel using the latest location of the first member; and
generating a folder accessible by the first member and other members having the identifications extracted at the extracting step.

9. The method according to claim 8, further comprising a controlling step for controlling assignment of access right for the folder by deleting a member not eligible to have access right and adding a member eligible to have access right.

10. The method according to claim 8, wherein the generating step informs link information of the folder to the first member and other members.

11. The method according to claim 8, wherein the substantially same time is defined as a predetermined time period including the reference time.

12. A program comprising computer-readable instructions that, when executed by a computer of a folder generating system, instructs the folder generating system to carry out a method of generating a folder accessible by a plurality of members including a first member having a first identification, the computer-readable instructions, comprising the steps of:
storing information of personnel, including a first member having a first identification, with respective identifications, detection locations and detection time;
receiving the first identification from the first member when the first member requests a folder generation at a reference time;
detecting a latest location of the first member from the stored information of personnel using the first identification received at the receiving step;
extracting identifications of other members, being presented with the first member at a substantially same time from the stored information of personnel using the latest location of the first member; and
generating a folder accessible by the first member and other members having the identifications extracted at the extracting step.

13. A folder generating system coupled to a plurality of terminals via a network, comprising:
a location managing unit configured to store information of personnel, including a first member having a first identification and a second member having a second identification and being remotely presented with the first member, with respective identifications, detection locations and detection time;
an identification information controlling unit configured to receive the first identification and the second identification from the first member when the first member requests a folder generation through one of the plurality of terminals via the network at a reference time;
an extracting unit configured to search the location managing unit for a latest location of the first member using the first identification received by the identification information controlling unit and to extract identifications of other members, being presented with the first member at a substantially same time, by searching the location managing unit using the latest location of the first member, and further configured to search the location managing unit for a latest location of the second member using the second identification received by the identification information controlling unit and to extract identifications of other members, being presented with the second member at the substantially same time, by searching the location managing unit using the latest location of the second member; and
a folder generating unit configured to generate a folder accessible by the first member, the second member, and other members having the identifications extracted by the extracting unit.

14. The folder generating system according to claim 13, wherein each of the personnel has an identification tag, which transmits respective identification.

15. The folder generating system according to claim 14, wherein the respective identification is read by an identification reader.

16. The folder generating system according to claim 13, further comprising an access-right controlling unit configured to control assignment of access right for the folder by deleting a member not eligible to have access right and adding a member eligible to have access right.

17. The folder generating system according to claim 13, wherein the folder generating unit informs link information of the folder to the first member, the second member, and other members having the identifications extracted by the extracting unit.

18. The folder generating system according to claim 13, wherein the substantially same time is defined as a predetermined time period including the reference time.
